(19) United States
(12) Patent Application Publication
(10) Pub. No.: US 2004/0095745 A1
(43) Pub. Date: May 20, 2004

(54) Multi-face lighting electro-luminescent cell

(76) Inventor: Chih Yuan Wang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/293,283

(22) Filed: Nov. 14, 2002

(51) Int. Cl. F21V 9/16

(52) U.S. Cl. 362/84

(57) ABSTRACT

Multi-face lighting electro-luminescent cell includes a transparent substrate and two lighting units disposed on the substrate at intervals. The transparent substrate is made of soft material and has a flexible section between the two lighting units. By means of bending the flexible section, the two lighting units can be positioned on the same plane or on different planes. The front electrode layer and the back electrode layer of the lighting unit control the lighting layer to emit light. The light beams emitted from the lighting layers are projected out through the transparent substrate.

### BACKGROUND OF THE INVENTION

The present invention is related to a multi-face lighting electro-luminescent cell, and more particularly to an electro-luminescent cell in which at least two lighting units are disposed on a flexible transparent substrate to provide multi-face backlight effect.

Electro-luminescent cell (EL) is applicable to backlight element, advertisement sign,. decorative article, etc.

Referring to FIG. 4, the EL is a thin sheet including a transparent substrate 81, a front electrode layer 82, a lighting layer 83, a back electrode layer 84 and an insulating packaging layer 85 sequentially overlaid on the substrate 81. An AC voltage is applied between the front electrode layer 82 and the back electrode layer 84 to make the lighting layer 83 emit light which is projected out through the transparent substrate 81.

The above EL can only provide backlight effect on one single face in the same lighting area. When applied to mobile phone with double panels, two ELs are necessary to provide backlight effect on both faces.

It should be noted that the double panels of the mobile phone have different sizes. Therefore, it is necessary to previously manufacture two patterns of molds for producing two different sizes of EL. Then the two sheets of EL 8 are assembled with the liquid crystal display module 9 as shown in FIG. 5 to achieve backlight effect on double faces in the same lighting area. Such measure is troublesome and time-consuming and leads to waste of material.

### SUMMARY OF THE INVENTION

It is therefore a primary object of the present invention to provide a multi-face lighting electro-luminescent cell including a transparent substrate and two lighting units disposed on the substrate at intervals. The transparent substrate is made of soft material and has a flexible section between the two lighting units. By means of bending the flexible section, the two lighting units can be positioned on the same plane or on different planes to emit light. The light beams emitted from the lighting layers are projected out through the transparent substrate. Accordingly, one single electro-luminescent cell can provide multi-face backlight effect.

It is a further object of the present invention to provide the above multi-face lighting electro-luminescent cell which can provide double-face backlight effect in the same lighting area instead of the two electro-luminescent cells in the conventional technique. Therefore, the material is saved and the working time is shortened.

The present invention can be best understood through the following description and accompanying drawings wherein:

### BRIEF DESCRIPTION OF THE DRAWINGS

FIG. 1 is a view showing the structure of the present invention;

FIG. 2 shows that the flexible section of the present invention is 180 bent;

FIG. 3 shows that the flexible section of the present invention is 90 bent;

FIG. 4 shows the structure of a conventional electro-luminescent cell; and

FIG. 5 shows that two conventional electro-luminescent cells are assembled with a liquid crystal display module.

### DETAILED DESCRIPTION OF THE PREFERRED EMBODIMENTS

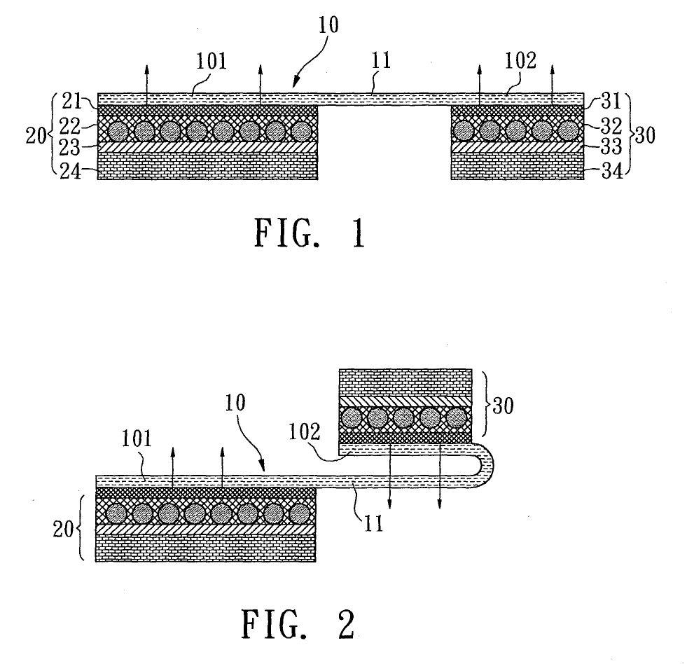

Please refer to FIG. 1. The multi-face lighting electro-luminescent cell (EL) of the present invention includes a transparent substrate 10 and at least two lighting units disposed on the substrate 1. In this embodiment, two lighting units 20, 30 are used and the light beams emitted by the two lighting units 20, 30 have the same color.

The transparent substrate 10 is made of soft material with flexibility. The lighting units 20, 30 are arranged on the transparent substrate 10 at intervals, whereby a section of the transparent substrate 10 between the lighting units 20, 30 forms a flexible section 11. Two sections of the transparent substrate 10 correspond to the lighting units 20, 30 are respectively defined as a first transparent section 101 and a second transparent section 102.

Each of the lighting units 20, 30 includes a front electrode layer 21, 31, a lighting layer 22, 32, a back electrode layer 23, 33 and a packaging layer 24, 34 sequentially overlaid on the substrate 10. The lighting layer 22, 32 is composed of more than one lighting powder and more than one resin. An AC voltage is applied by a drive circuit between the front electrode layer 21, 31 and the back electrode layer 23, 33 to make the lighting layer 22, 32 of the lighting units 20, 30 emit light. The light beams emitted from the lighting layers 22, 32 are respectively projected out through the first and second transparent sections 101, 102.

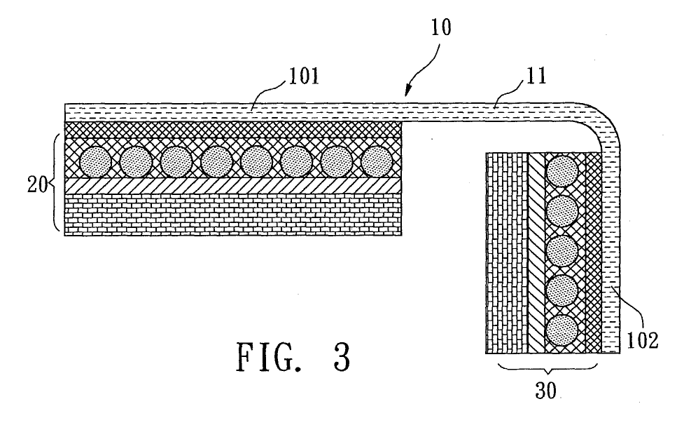

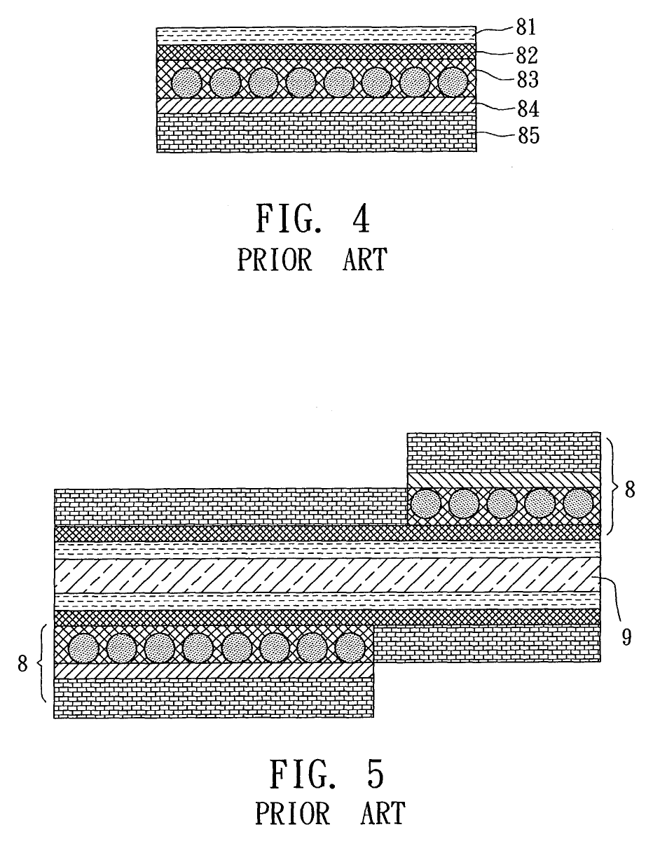

By means of the flexible section 11 of the transparent substrate 10, the first and second transparent sections 101, 102 can be positioned on the same plane as necessary as shown in FIG. 1. Alternatively, the flexible section 11 can be 180 bent to make the first and second transparent sections 101, 102 oppositely directed as shown in FIG. 2. Alternatively, the flexible section 11 can be 90 bent to make the first and second transparent sections 101, 102 normal to each other and directed in different directions as shown in FIG. 3. No matter by what angle the flexible section 11 is bent, the electro-luminescent cell of the present invention can emit light to provide backlight effect on multiple faces.

In the case that the electro-luminescent cell of the present invention is bent into a pattern as shown in FIG. 2, the present invention can provide double-face backlight effect in the same lighting area instead of the two electro-luminescent cells in the conventional technique. Therefore, the material is saved and the working time is shortened.

In conclusion, the flexible section 11 of the soft transparent substrate 10 can be bent to make the two lighting units 20, 30 emit light on the same plane or on different planes. Accordingly, one single electro-luminescent cell can provide multi-face backlight effect.

The above embodiment is only used to illustrate the present invention, not intended to limit the scope thereof. Many modifications of the above embodiment can be made without departing from the spirit of the present invention. For example, the two lighting units can have different colors.

What is claimed is:

1. A multi-face lighting electro-luminescent cell comprising a transparent substrate and at least two lighting units disposed on the substrate, the transparent substrate being made of soft material with flexibility, the lighting units being arranged on the transparent substrate at intervals, whereby a section of the transparent substrate between the lighting units forms a flexible section, each of the lighting units including a front electrode layer, a lighting layer, a back electrode layer and a packaging layer sequentially overlaid on the substrate, whereby by means of the front electrode layer and the back electrode layer, the lighting layers of the lighting units are controlled to emit light, the light beams emitted from the lighting layers being projected out through the transparent substrate.

2. The multi-face lighting electro-luminescent cell as claimed in claim 1, wherein each lighting layer is composed of more than one lighting powder and more than one resin.

3. The multi-face lighting electro-luminescent cell as claimed in claim 1, wherein the light beams emitted by the lighting layers have the same color.

4. The multi-face lighting electro-luminescent cell as claimed in claim 1, wherein the lighting layers are respectively blended with different colors of materials so that the light beams emitted by the lighting layers have different colors.
